(19) United States
(12) Patent Application Publication
(10) Pub. No.: US 2009/0284231 A1
(43) Pub. Date: Nov. 19, 2009

(54) Electric generating system with energy transfer device

(75) Inventor: Kao Min Hong, Taichung (TW)

Correspondence Address: BACON & THOMAS, PLLC, 625 SLATERS LANE, FOURTH FLOOR, ALEXANDRIA, VA, 22314-1176, US

(73) Assignee: CHENG WANG Computer Technology Co., Ltd., Taichung (TW)

(21) Appl. No.: 12/153,203

(22) Filed: May 15, 2008

(51) Int. Cl. H02P 9/00

(52) U.S. Cl. 322/35

(57) ABSTRACT

This invention provides an electric generating system with energy transfer device for accumulating and transferring the compressed medium to produce driving force for generating electric power. Once the electric generator start generating electric power, the driving force can be transmitted simultaneously to a medium compressor to compress the medium in the pressure reservoir for accumulating pressure. The compressed medium can be released automatically and properly to push the fan wheel to rotate by a pressure release valve when the driving force of the electric generator is stopped so as to provide extra driving force to operate the electric generator continuously.

### BACKGROUND OF THE INVENTION

(1) Field of the Invention

This invention relates to an electric generating system with energy transfer device, especially an electric generating system having pressure reservoir for accumulating compressed medium which can be released to produce extra driving force for generating electric power when the driving force of the electric generator is stopped.

(2) Description of the Prior Art

The transfer of “work” and “energy” is a kind of physical property. For the traditional electric generator, it is worked by the mechanical rotation energy to produce electric power for electric appliances. The surplus electric power is stored in the lead acid battery to provide extra driving force when the driving force of the electric generator is stopped.

However, the traditional lead acid battery is composed of the liquid chemical acid electrolyte and the solid heavy metal conductor. Consequently, any discarded traditional lead acid battery may cause environmental pollution or being hazardous to human health eventually.

### SUMMARY OF THE INVENTION

It is therefore the main object of this invention to provide an electric generating system having pressure reservoir for accumulating compressed medium. Once the electric generator starts generating electric power, the driving force can be transmitted simultaneously to a medium compressor to compress the medium in the pressure reservoir for accumulating pressure. The compressed medium can be released automatically and properly to push the fan wheel to rotate by a pressure release valve when the driving force of the electric generator is stopped so as to provide extra driving force to operate the electric generator continuously.

It is another object of this invention to provide an electric generating system with energy transfer device which can replace the traditional lead acid battery to provide extra force for generating electric power.

### BRIEF DESCRIPTION OF THE DRAWINGS

In the drawings, which illustrate the preferred embodiments and modes of operation of this invention, and in which like reference characters designate the same or similar parts throughout the several views:

FIG. 1 is a flow chart showing the operation process of an electric generating system with energy transfer device of this invention.

### DETAILED DESCRIPTION OF THE PREFERRED EMBODIMENTS

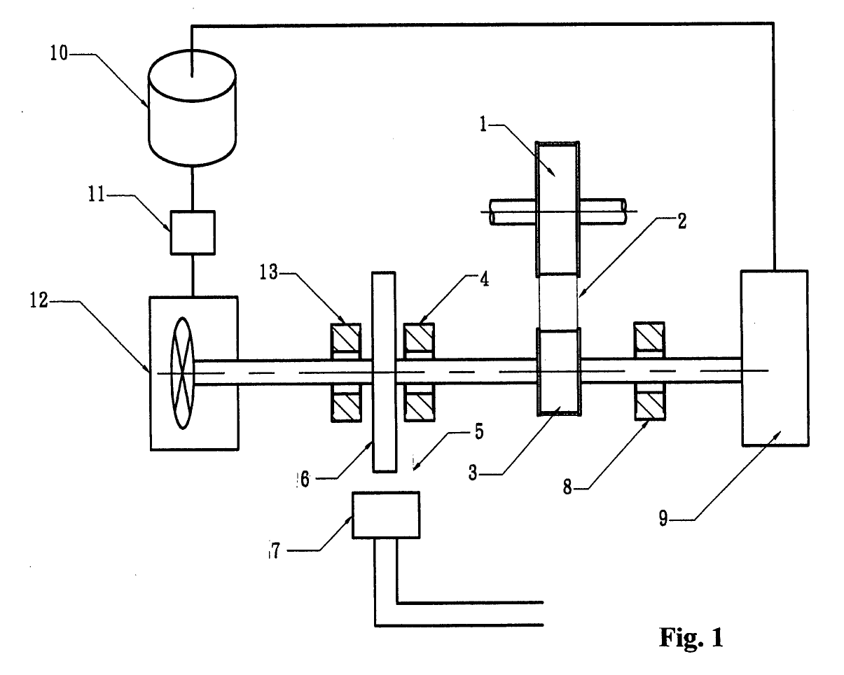

Referring to FIG. 1, the present invention, an electric generating system with energy transfer device, is composed of a driving wheel 1, a driving belt, a driven wheel 3, a first overdrive clutch 4, an electric generator 5, a one-way clutch 8, a medium compressor 9, a pressure reservoir 10, a fan wheel 12 and a second overdrive clutch 13.

The driven wheel 3 can be driven to rotate by the driving wheel 1 with the driven belt 2, the driving force of the driven wheel 3 being transmitted to the rotor 6of the electric generator 5 by the first overdrive clutch 4 to induce the stator coil 7 of the electric generator 5 to generate electric power. The driving force of the driven wheel also can be transmitted to the medium compressor 9 by the one-way clutch 8 to compress the medium in the pressure reservoir 10 for accumulating pressure.

Once the driving force of the driving wheel 1 is stopped, the compressed medium accumulated in the pressure reservoir 10 can be released automatically and properly to push the fan wheel 12 to rotate by the pressure release valve 11. The driving force of the fan wheel 12 can drive the rotor 6 of the electric generator 5 by the second overdrive clutch 13 to induce the stator coil 7 to generate electric power. Accordingly, it is not necessary to use any of the traditional lead acid battery for this electric generating system with energy transfer device.

However, the medium of this invention can be liquid or air, such as water, oil or gas. The medium compressor 9 can be a pump, a reciprocating or rotary compressor. As to the overdrive clutch 4, 12, it can be ball bearing clutch, electromagnetic clutch or mechanical clutch.

It is understood with those skills in the art that the foregoing description is a preferred embodiment of the disclosed device and that various changes and modifications may be made in the invention without departing from the spirit and scope thereof.

I claim:

1. An electric generating system with energy transfer device comprising:
a driving wheel;
a driven wheel which is driven to rotated to rotated by said driving wheel with a driving belt;
an electric generator having rotor and stator coil, the driving force of said driven wheel can drive the rotor to induce the stator coil to generate electric power;
a one-way clutch;
a pressure reservoir in which having medium;
a medium compressor, the driving force of said driven wheel also can be transmitted to the medium compressor by said one-way clutch to compressor the medium in said pressure reservoir for accumulating pressure;
a fan wheel;
once the driving force of the driving wheel is stopped, the compressed medium accumulated in said pressure reservoir can be released automatically and properly to push the fan wheel to rotate by a pressure release valve and drive the rotor of said electric generator to induce the stator coil to generate extra electric power.

2. An electric generating system with energy transfer device as claimed in claim 1, wherein the medium is liquid or air.

3. An electric generating system with energy transfer device as claimed in claim 1, wherein the medium compressor is a pump, a reciprocating or rotary compressor.

4. An electric generating system with energy transfer device as claimed in claim 1, wherein the overdrive clutch is a ball bearing clutch, a mechanical clutch or an electromagnetic clutch.
